(19) United States
(12) Patent Application Publication
(10) Pub. No.: US 2007/0095034 A1
(43) Pub. Date: May 3, 2007

(54) Dust collecting apparatus for vacuum cleaner

(75) Inventors: Jung-gyun Han, Gwangju-city (KR); Jang-keun Oh, Gwangju-city (KR); Min-ha Kim, Gwangju-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD

(21) Appl. No.: 11/406,597

(22) Filed: Apr. 19, 2006

(30) Foreign Application Priority Data
Oct. 28, 2005 (KR) 10-2005-0102618

(51) Int. Cl. B01D 45/12

(52) U.S. Cl. 55/459.3

(57) ABSTRACT

Disclosed is a cyclone dust collecting apparatus for a vacuum cleaner, which includes: a cyclone main body rotating a drawn air flown into a first inlet and discharging; and a guide unit disposed between the first inlet and the cyclone chamber, and guiding the drawn air into the cyclone chamber, while dispersed into two or more parts, and the guide unit further comprises a plurality of guide paths spirally formed to guide the drawn air flown into the cyclone chamber rotates along the spiral guide paths. Accordingly, rotary force of the air flown into the cyclone chamber increases and pressure loss of the vacuum cleaner by the cyclone dust collecting apparatus is minimized.

### CROSS-REFERENCE TO RELATED APPLICATIONS

This application claims benefit under 35 U.S.C. § 119(a) of Korean Patent Application No. 2005-102618, filed Oct. 28, 2005, in the Korean Intellectual Property Office, the entire contents of which are incorporated herein by reference.

### BACKGROUND OF THE INVENTION

1. Field of the Invention

The present invention relates to a vacuum cleaner. More particularly, the present invention relates to a dust collecting apparatus for a vacuum cleaner, which separates dusts from an air externally drawn.

2. Description of the Related Art

Generally, a vacuum cleaner draws dusts on a surface to be cleaned together with air and separates the dusts from the drawn air, to clean the surface to be cleaned. The vacuum cleaner includes a dust collecting apparatus collecting the dusts separated from the drawn air. Recently, a cyclone dust collecting apparatus is used as the dust collecting apparatus. The cyclone dust collecting apparatus uses centrifugal force generated by rotating the drawn air, to separate the dust from the drawn air.

U.S. Pat. No. 6,042,628 discloses one example of the abovementioned cyclone dust collecting apparatus. The conventional cyclone dust collecting apparatus includes a cyclone chamber where the drawn air rotates, a dust collecting chamber where the dust separated from the drawn air rotating in the cyclone chamber is collected, and a guide member which disperses and guides the drawn air in a tangential direction of the cyclone chamber. Based on the above structure, it is advantageous that the drawn air dispersed by the guide member is discharged towards an inner wall surface of the cyclone chamber, descends and rotates, and accordingly a rotation velocity of the drawn air rotating inside the cyclone chamber can be accelerated. However, according to the conventional cyclone dust collecting apparatus, there is a problem. Just after the drawn air is discharged from the guide member, a descending operation of the drawn air is interfered by the drawn air rotating inside the cyclone chamber so that the flow rate of the drawn air may decrease. If the flow rate of the drawn air decreases, there is an increasing suction loss of the vacuum cleaner. Due to the suction loss, consumption power and suction force cleaning of the vacuum cleaner drop and efficiencies of the vacuum cleaner fall. Accordingly, there is a need of developing a cyclone dust collecting apparatus minimizing the loss of the abovementioned pressure.

### SUMMARY OF THE INVENTION

An aspect of the present invention is to solve at least the above problems and/or disadvantages of the related art and to provide at least the advantages described below. Accordingly, an aspect of the present invention is to provide a cyclone dust collecting apparatus of a vacuum cleaner, which has improved structures to enhance cleaning efficiencies of the vacuum cleaner through reduction of pressure loss.

In order to achieve the above-described aspects of the present invention, there is provided a dust collecting apparatus for a vacuum cleaner separating dust from a drawn air, using a centrifugal force generated by rotating the drawn air. The dust collecting apparatus for the vacuum cleaner includes: a cyclone main body having a first inlet through which the drawn air flows, a cyclone chamber where the drawn air rotates and a first outlet where an air discharged from the cyclone chamber is guided; and a guide unit disposed between the first inlet and the cyclone chamber. The guide unit guides the drawn air into the cyclone chamber, while dispersed into two or more parts. The guide unit further comprises a plurality of guide paths spirally formed to guide the drawn air into the cyclone chamber along the spiral guide paths.

It is possible to reduce pressure loss by interference of the drawn air flowing into the cyclone chamber, to enhance cleaning efficiency of the vacuum cleaner.

According to one embodiment of the present invention, the guide unit comprises: a guide wall having a first side facing the first inlet, a second side facing the cyclone chamber, a plurality of second inlets penetrating the guide wall, and a plurality of guide ducts formed to correspond to the plurality of second inlets, the plurality of guide ducts being formed on the second side of the guide wall.

The guide unit may further comprise a plurality of second outlets penetrating the guide wall to discharge the drawn air free of dust therethrough; and a guide cover having a partition wall partitioning the drawn air flowing into the second inlets and the clean air discharged through the second outlets. The guide cover covering the first side of the guide wall. A first connection path connecting the first and the second inlets, and a second connection path connecting the first and the second outlets are partitioned between the guide cover and the guide wall.

The second inlets and outlets of the guide ducts facing an inside the cyclone chamber may be formed on a slope.

Each guide ducts may comprises a sloped plane on an outer circumference of the guide ducts, so that the drawn air discharged from other guide ducts at the upstream is guided along the sloped plane rotationally, and the drawn air discharged from the guide ducts at the upstream is guided to be far from the second inlets by the sloped plane.

At least a part of at least two of the guide ducts may overlap with each other so that the outlets of each guide ducts are consecutively disposed further from the second side of the guide wall.

The outlets of the guide ducts at the downstream of the drawn air may be narrower than outlets of the guide ducts at the upstream.

The guide wall may cover one side of the cyclone chamber facing the first inlet and prevent the drawn air into the cyclone chamber from being flown back into the first inlet.

In order to achieve the above-described aspects of the present invention, there is provided a cyclone dust collecting apparatus for a vacuum cleaner comprising a plurality of guide ducts communicated with a plurality of air inlets, respectively, and a rotary force of an external air increases while the external air passes through the plurality of guide ducts.

In one embodiment, the plurality of air inlets and the guide ducts may be symmetrically disposed with reference to the air discharging holes.

In other embodiment, the plurality of air inlets and the guide ducts may be asymmetrically disposed with reference to the air discharging holes.

A sectional area of the plurality of guide ducts may get larger, and a height of the plurality of guide ducts may increase as the guide ducts are further from the air inlets.

At least one of the plurality of guide ducts may be disposed in an upward and downward direction of at least one other guide duct.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a cyclone dust collecting apparatus of the present invention;

FIG. 2 is an exploded view of the cyclone dust collecting apparatus of FIG. 1;

FIG. 3 shows a lower side of a guide wall of FIG. 2;

FIG. 4 shows a lower side of a guide cover of FIG. 2;

FIG. 5 is a plan view of an operation state of the cyclone dust collecting apparatus of the present invention;

FIG. 6 shows a lower side of a second embodiment of a guide wall according to the present invention;

FIG. 7 is a graph showing changes in pressure loss between the cyclone dust collecting apparatus of the present invention and a conventional cyclone dust collecting apparatus; and

FIG. 8 is a lower side of a third embodiment of a guide wall according to the present invention.

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

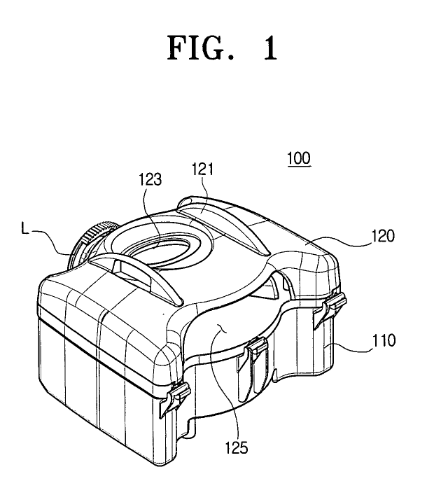

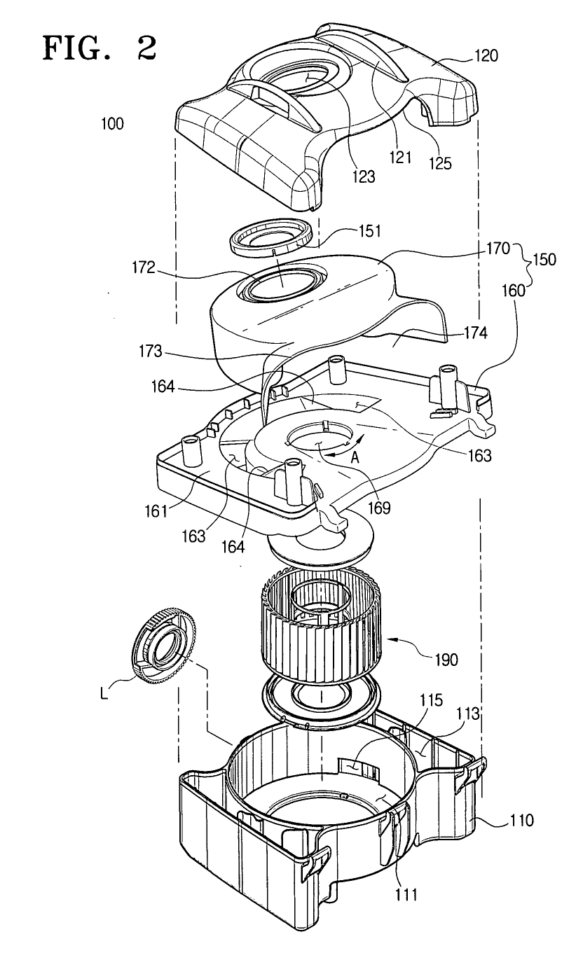

Referring to FIGS. 1 and 2, a cyclone dust collecting apparatus 100 of the present invention includes a cyclone main body 110, a guide unit 150, a cover member 120, and a filter unit 190. For reference, cyclone dust collecting apparatus 100 can include a locking member L for locking the cover member 120 and the cyclone main body 110 to one another.

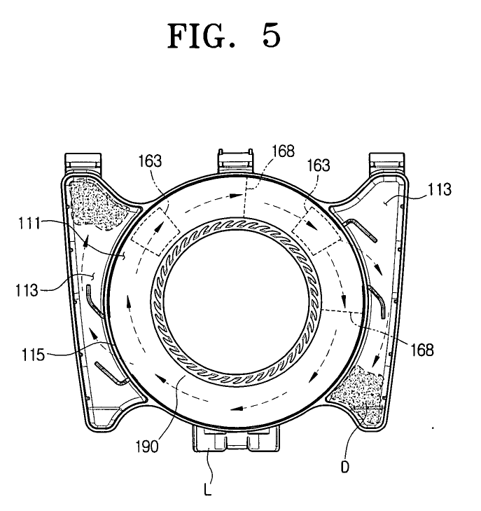

The cyclone main body 110 is internally partitioned with a cyclone chamber 111 and a dust collecting chamber 113. The cyclone main body 110 is shaped like a chamber having an open upper side. The cyclone chamber 111 is where a air drawn-in from outside of apparatus 100 through a first inlet 123 formed through the cover member 120 is rotated. The dust collecting chamber 113 is where that the dust separated by the centrifugal force in the rotated air is gathered. Upper sides of the cyclone chamber 111 and the dust collecting chamber 113 are closed by the later-mentioned guide unit 150 and the cover member 120. According to an embodiment of the present invention, dust collecting chamber 113 comprises a plurality of dust collecting chambers 113 that enclose a part of the side outer wall of the cyclone chamber 111, as illustrated in FIG. 5. The dust collecting chamber 113 is connected to the cyclone chamber 111 through a dust passage hole 115 penetrating through an inner wall of the cyclone chamber.

As mentioned above, the cover member 120 is formed on upper side of the cyclone main body 110, and includes the first inlet 123 and a first outlet 125. Cover member 120 can also include one or more handles 121. The first outlet 125 is a passage through which dust-free air from the cyclone chamber 111 is discharged. Since the first inlet 123 and the first outlet 125 are formed on the cover member 120, and the dust collecting chamber 113 is formed on a side outer wall of the cyclone chamber 111, the cyclone dust collecting apparatus 100 can be formed with a lower height than the conventional cyclone dust collecting apparatus, to accordingly achieve a compact-sized cyclone dust collecting apparatus 100.

The guide unit 150 guides the drawn air into the cyclone chamber 111, and guides the air discharged from the cyclone chamber 111 towards the first outlet 125. Towards this goal, according to a first embodiment of this present invention, the guide unit 150 includes a guide wall 160 partitioning the cover member 120 and the cyclone main body 110, and a guide cover 170.

Cyclone dust collecting apparatus 100 can also include a sealing member 151 for sealing the space between the guide cover 170 and the first inlet 123.

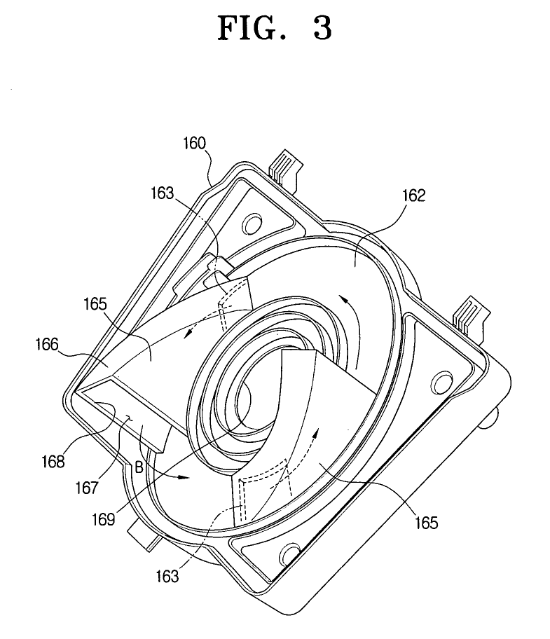

As illustrated in FIGS. 2 and 3, the guide wall 160 covers the upper sides of the cyclone chamber 111 and the dust collecting chambers 113, and includes a first side 161 facing the first inlet 123, a second side facing the cyclone chamber 111. The guide wall also includes a plurality of second inlets 163, a plurality of guide ducts 165, and a plurality of second outlets 169. The guide wall 160 closes the upper parts of the dust collecting chamber 113 and the cyclone chamber 111. By sealing the space between the cyclone chamber 111 and the guide wall 160, the air having gone through the guide wall may not flow back toward the first inlet 123.

The plurality of second inlets 163 penetrate through the guide wall 160 to connect the cyclone chamber 111 to the first inlet 123, and guide the drawn air flown through the first inlet 123 into the cyclone chamber 111. The plurality of second inlets 163 may draw more air into the cyclone chamber 111 than the conventional cyclone dust collecting apparatus. Accordingly, it is possible to prevent suction force of the vacuum cleaner due to the cyclone dust collecting apparatus 100 from dropping, and consumption power from falling. For reference, the consumption power indicates work done by the vacuum cleaner under a predetermined condition. The consumption power is a term generally used as one example showing an efficiency of the cleaner in the related industry.

According to the embodiment of the present invention, the plurality of second inlets 163 comprise a pair of second inlets 163 provided. The drawn air flowing through the first inlet 123 is equally distributed and flown into the cyclone chamber 111 through the pair of second inlets 163. According to the embodiment of the present invention, each second inlet 163 has a sloped part of the rim to guide the drawn air inward the guide ducts 165 in a sloped direction. The abovementioned second inlets 163 may be disposed outside an imaginary area (A) formed by straight lines connecting the first outlet 125 and the second outlets 169, which will be described later. It is easier to form the guide cover 170 described later in order for the air flowing into the cyclone chamber 111 and the air flowing from the cyclone chamber 111 not to be mutually interfered. According to the embodiment of the present invention, the second inlets 163 are disposed further than the second outlets 169 from the first outlet 125.

The plurality of guide ducts 165 each include a guide path 167 internally penetrating and a sloped plane 166 externally formed. The plurality of guide ducts 165 protrude on a second side of the guide wall 160 to correspond to each of the second inlets 163. The guide path 167 enhances rotary force of the drawn air flowing into the cyclone chamber 111, and minimizes the interference of the drawn air with the air inside the cyclone chamber 111. Towards this goal, the guide path 167 has an outlet 168 thereof formed at a predetermined angle with respect to the second inlets 163 to guide the drawn air in a direction tangential to the cyclone chamber 111. According to the embodiment of the present invention, the guide path 167 is spirally formed to guide the drawn air to rotate along an inner wall of the cyclone chamber 111, while the drawn air is gradually descending towards a lower part of the cyclone chamber. There is a height between the guide path 167 and the guide wall 160 that gradually increases toward the outlet 168. A sectional area of the guide path may be kept uniform along the direction of the drawn air proceeding toward the outlet 168 of the guide ducts 165 from the second inlets 163. Accordingly, it is possible to have uniform air flows inside the guide ducts, to minimize pressure loss caused by changes of proceeding direction of the drawn air as abovementioned.

The sloped plane 166 is formed on one side facing a bottom side of the cyclone chamber 111 among outer circumference sides of the guide ducts 165. According to the embodiment of the present invention, the sloped plane 166 is bent considering the guide path 167 formed inside the guide ducts 165. The drawn air gets out of the guide path 167 and is guided to rotate downward along the inner wall of the cyclone chamber 111 by the sloped plane 166. The guide ducts 165 minimize the interference between the air rotating inside the cyclone chamber 111 and the air flown into the cyclone chamber 111, accordingly minimizing the pressure loss of the vacuum pressure due to the cyclone dust collecting apparatus 100.

The second outlets 169 are a passage through which the drawn air having downwardly rotated and ascended is guided externally of the cyclone chamber 111. According to the embodiment of the present invention, on a lower part of the second outlets 169 are mounted with a filter unit to further separate minute dusts from the drawn air discharged from the cyclone chamber 111.

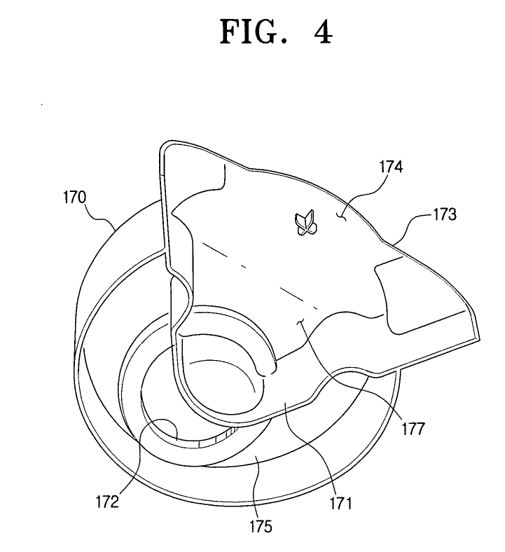

As abovementioned, as the second inlets 163 and the second outlets 169 are on the guide wall 160, the air drawn through the first inlet 123 and the air discharged through the first outlet 125 are mutually interfered between the cover member 120 and the guide wall 160. According to the embodiment of the present invention, the cyclone dust collecting apparatus 100 includes the guide cover 170 in order to prevent the first inlet 123 and the first outlet 125 from being mutually interfered. The guide cover 170, as illustrated in FIGS. 2 and 4, includes a partition wall 171 and a cutting unit 173. The partition wall 171 protrudes towards the guide wall 160 from an inner side of the guide cover 170. A lower part of the partition wall 171 blocks space between the second inlets 163 and the second outlets 169, when the guide cover 170 and the guide wall 160 are combined. The cutting unit 173 is formed by opening one end of the guide cover 170 facing the first outlet 125. The cutting unit 173 forms an outlet 174 connected to the first outlet 125, between the cutting unit 173 and the guide wall 160, when the guide cover 170 and the guide wall 160 are combined. In the abovementioned partition wall 170 and the cutting unit 173, internal space between the guide cover 170 and the guide wall 160 are partitioned with a first connection path 175 where the air flowing from the first inlet 123 passes and a second connection path 177 where the air discharged through the first outlet 125 passes.

Hereinafter, the operation of the above structured cyclone dust collecting apparatus according the embodiment of the present invention will be described.

When the main body of the vacuum cleaner is driven, an external air is drawn through the first inlet 123. The air drawn through the first inlet 123 flows into the first connection path 175 through an inlet 172 of the guide cover 170 and is dispersed into the second inlets 163. The air dispersed into second inlets 163 passes through each guide paths formed inside each guide ducts 165, and flows into the cyclone chamber. As abovementioned, the drawn air flowing into the cyclone chamber is guided to rotate downwardly along the inner wall of the cyclone chamber 111 by the guide paths 167. After that, the drawn air discharges externally of the cyclone chamber 111 through the filter unit 190 and the second outlets 169. The drawn air discharged through the second outlets 169 consecutively passes through the second guide path 177, the outlet 174 of the second guide path 177 and the first outlet 125, and discharges externally of the cyclone dust collecting apparatus 100.

As illustrated in FIG. 5, dust (D) included in the drawn air are separated from the drawn air by centrifugal force generated when the drawn air rotates. The dust passes through the dust passage hole 115 and are housed in the dust collecting chamber 113.

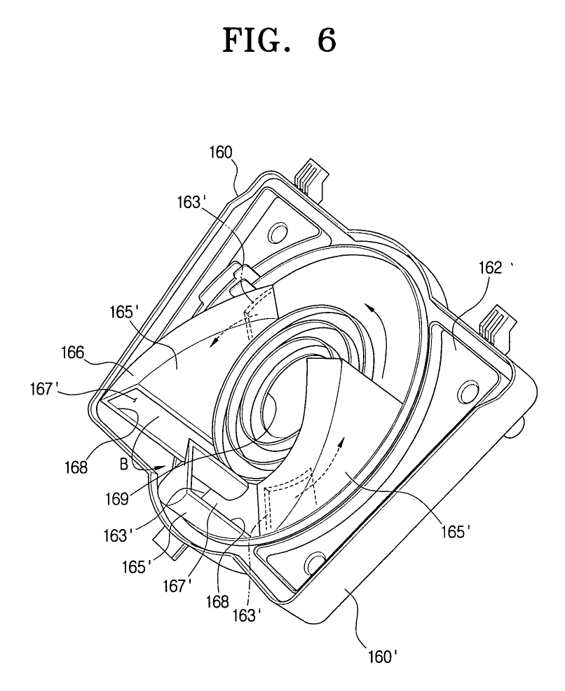

FIG. 6 shows a lower side of a guide wall 160′ of a cyclone dust collecting apparatus according to the second embodiment of the present invention. According to this embodiment of the present invention, the guide wall 160′ is formed with three second inlets 163′ and three guide ducts 165′ corresponding thereto. Like the first embodiment discussed above, the second inlets 163′ are disposed radially with reference to second outlets 169 in the center, and equal spaced therebetween. As abovementioned, the increased number of the second inlets 163′ and the guide ducts 165′ leads more drawn air drawn flowing into cyclone chamber 111 (refer to FIG. 1) than the first embodiment, during the same hour. Accordingly, pressure loss by the cyclone dust apparatus 100 (refer to FIG. 1) decreases.

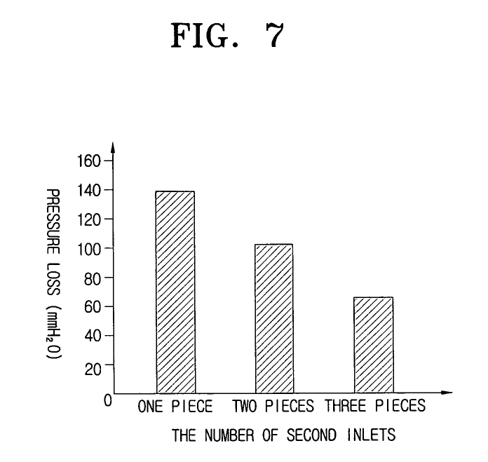

FIG. 7 illustrates comparison between the first and second embodiments, for pressure loss by the cyclone dust collecting apparatus 100 according to the number of the second inlets 163, 163′, while motor forces, shapes of the second inlets 163, 163′ and the guide ducts 165, 165′ and shapes of the cyclone chamber are the same between two embodiments. Referring to FIG. 7, as the number of the second inlets 163, 163′ increases, the more the pressure loss of the vacuum cleaner lowers. However, considering motor capacity of the vacuum cleaner and the limit of the cyclone dust collecting apparatus 100 in terms of design, the number of the second inlets 163, 163′ may be three.

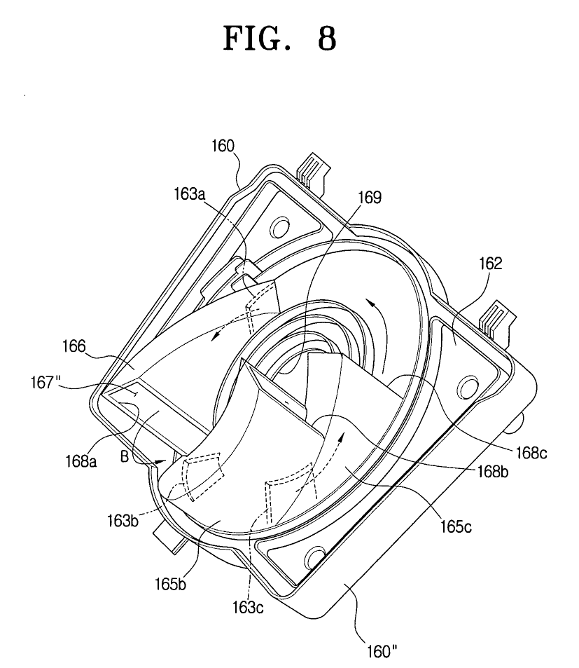

FIG. 8 shows a guide wall of a cyclone dust collecting apparatus according to a third embodiment of the present invention. Referring to FIG. 8, the cyclone dust collecting apparatus 100 according to the embodiment of the present invention includes a first through three guide ducts 165a, 165b and 165c, and outlets 168a, 168b and 168c of each guide ducts 165a, 165b and 165c are differently shaped and located from the first and second embodiments.

According to this embodiment of the present invention, the outlets 168a, 168b and 168c of each guide ducts 165a, 165b and 165c are formed smaller, downward along the rotation direction B of the drawn air inside the cyclone chamber 111. As the drawn air rotating inside the cyclone chamber 111 goes downward, the rotary force decreases. The decreased rotary force may be enhanced by making the drawn air flow quicker into the cyclone chamber 111 through the third guide duct 165a, than the drawn air discharged from the first guide duct 165a.

According to the embodiment of the present invention, one of the guide paths 167a, 167b and 167c overlaps with other guide duct along the direction further from the second side 162. According to the embodiment of the present invention, a part of the second guide duct 165b overlaps with a part of the third guide duct 165c. Each space between the outlets 168a, 168b and 168c of the guide ducts 165a, 165b and 165c, and the second side 162 are different. Although the rotary force of the drawn air rotating inside the cyclone chamber 111 gets smaller as the drawn air gets further from the guide wall 160″, the rotary force is strengthened by the drawn air discharged through the outlet 168b of the guide path 165b far from the second side 162. The guide wall 160″ and the guide cover 170 (refer to FIG. 2) may have various changes in form where the drawn air rotates inside a first connection passage 175. However, there may be a problem of unstable air flow inside the cyclone chamber 111. However, the problem may be solved by making various changes in form and details for second inlets 163a, 163b and 163c, and the guide ducts 165a, 165b and 165c.

Based on the above description, according to the present invention, an air flow inside a cyclone dust collecting apparatus through a first inlet is dispersed through a plurality of second inlets, and flows inside a cyclone chamber. It is possible to minimize pressure loss caused by the interference of the drawn air inside the cyclone chamber, to enhance cleaning efficiency of a vacuum cleaner.

The drawn air having passed trough the plurality of second inlets is guided by a plurality of guide ducts spirally formed, and the rotary force of the drawn air decreases at the point when the drawn air enters into the cyclone chamber. Accordingly, dust collecting efficiencies are enhanced.

It is possible to prevent the rotary force of the drawn air rotating inside the cyclone chamber from decreasing, as the drawn air gets further from the second inlets, by varying sizes and forms of the plurality of guide ducts. Accordingly, cleaning efficiencies of the cyclone dust collecting apparatus may be enhanced.

While the invention has been shown and described with reference to certain embodiments thereof, it will be understood by those skilled in the art that various changes in form and details may be made therein without departing from the spirit and scope of the invention as defined by the appended claims.

What is claimed is:

1. A dust collecting apparatus for a vacuum cleaner for separating dust from drawn air using a centrifugal force generated by rotating the drawn air, the dust collecting apparatus comprising:
a cyclone main body comprising:
a first inlet where the drawn air is drawn into the cyclone main body;
a cyclone chamber where the drawn air rotates; and
a first outlet where an air discharged from the cyclone chamber is guided from the cyclone main body; and
a guide unit disposed between the first inlet and the cyclone chamber, and the guide unit guiding the drawn air into the cyclone chamber, while dispersing the drawn air into two or more parts,
wherein the guide unit further comprises a plurality of guide paths spirally formed to guide the drawn air into the cyclone chamber along the spiral guide paths.

2. The dust collecting apparatus of claim 1, wherein the guide unit comprising:
a guide wall comprising:
a first side facing the first inlet; and
a second side facing the cyclone chamber,
a plurality of second inlets penetrating the guide wall; and
a plurality of guide ducts corresponding number to the plurality of second inlets, the plurality of guide ducts being formed on the second side of the guide wall.

3. The dust collecting apparatus of claim 2, wherein the guide unit further comprises:
a plurality of second outlets penetrating the guide wall to discharge the drawn air free of dust therethrough; and
a guide cover having a partition wall partitioning the drawn air flowing into the plurality of second inlets and the clean air discharged through the plurality of second outlets, and covering the first side of the guide wall,
wherein a first connection path connecting the first inlet and the plurality of second inlets, and a second connection path connecting the first outlet and the plurality of second outlets are partitioned between the guide cover and the guide wall.

4. The dust collecting apparatus of claim 2, wherein the plurality of second inlets are formed on a slope.

5. The dust collecting apparatus of claim 4, wherein each of the plurality of guide ducts comprises a sloped plane on an outer circumference of the guide ducts so that the drawn air discharged from upstream guide ducts is guided along the sloped plane rotationally, and
the drawn air discharged from the upstream guide ducts is guided away from the plurality of second inlets by the sloped plane.

6. The dust collecting apparatus of claim 5, wherein at least of a part of at least two of the plurality of guide ducts overlap with each other.

7. The dust collecting apparatus of claim 2, wherein the outlets of the guide ducts at the downstream of the drawn air are narrower than outlets of the guide ducts at the upstream.

8. The dust collecting apparatus of claim 2, wherein a part of rims of each of the plurality of second inlets are formed at the same angle as insides of the guide ducts.

9. The dust collecting apparatus of claim 2, wherein the guide wall covers one side of the cyclone chamber facing the first inlet and prevent the drawn air into the cyclone chamber from being flown back into the first inlet.

10. A cyclone dust collecting apparatus for a vacuum cleaner which rotates a drawn air externally flown through a plurality of air inlets, to separate dust from the air and discharges a clean air through air outlets, the cyclone dust collecting apparatus comprising:
a plurality of guide ducts communicated with the plurality of the air inlets, respectively,
wherein a rotary force of an external air increases while the external air passes through the plurality of guide ducts.

11. The cyclone dust collecting apparatus of claim 10, wherein the plurality of air inlets and the plurality of guide ducts are symmetrically disposed with reference to the air outlets.

12. The cyclone dust collecting apparatus of claim 10, wherein the plurality of air inlets and the plurality of guide ducts are asymmetrically disposed with reference to the air outlets.

13. The cyclone dust collecting apparatus of claim 10, wherein the plurality of guide ducts have a sectional area that gets larger as the plurality of guide ducts are further from the plurality of air inlets.

14. The cyclone dust collecting apparatus of claim 10, wherein the plurality of guide ducts have a height that increases as the plurality of guide ducts are further from the plurality of air inlets.

15. The cyclone dust collecting apparatus of claim 10, wherein at least one of the plurality of guide ducts is disposed in an upward and downward direction of at least one other guide duct.
